(19) United States
(12) Patent Application Publication
(10) Pub. No.: US 2016/0117380 A1
(43) Pub. Date: Apr. 28, 2016

(54) SYSTEM AND METHOD FOR CREATING INTERACTIVE META-CONTENT

(71) Applicant: ABorC, Inc., Woodland Hills, CA (US)

(72) Inventors: JENNIE WONG, Woodland Hills, CA (US); STEPHEN ANDREW KRAUSE, Woodland Hills, CA (US); MARIA MARGARET WRIGHT, Berea, KY (US)

(21) Appl. No.: 14/742,384

(22) Filed: Jun. 17, 2015

Related U.S. Application Data
(60) Provisional application No. 62/014,047, filed on Jun. 18, 2014.

(51) Int. Cl. G06F 17/30; G09B 7/00; G09B 5/06; G09B 5/02; G09B 5/04

(52) U.S. Cl. CPC G06F 17/30598; G09B 5/02; G09B 5/04; G09B 5/06; G09B 7/00

(57) ABSTRACT

A system and method for creating interactive content from primary content is disclosed, whereby the user can use interactive meta-content in lieu of interacting with some or all of the primary content.

### CROSS REFERENCE TO RELATED APPLICATION

This application claims priority under 35 USC 119 from US Provisional Application Ser. No. 62/014,047 titled A METHOD FOR CREATING INTERACTIVE META-CONTENT filed on Jun. 18, 2014 by Jennie WONG et al., the entire disclosure of which is incorporated herein by reference.

### FIELD OF THE INVENTION

The invention is related to computer systems with interactive content and, more specifically, to using interactive meta-content, which is content about other content.

### BACKGROUND OF THE INVENTION

There are currently various types of known content models, each with certain known disadvantages. There is primary content, which addresses a specific subject matter. There is interactive content is specifically intended for user interaction and provides the user the ability to affect the content and there is meta-content, which is content about other content (such as academic meta-analyses which are studies of studies) and defined as content that sets up the presentation or behavior of the rest of the content, or that sets up the relationship of a document with other documents, or that conveys other information.

Each type of content model has some disadvantages. For example, the disadvantage of a primary content model is that it is far exceeding the user's ability to read, review, listen, watch, or understand all of it. With respect to the interactive content, there is currently no methodical means by which interactive content can be created from the primary content of interest. Another example is meta-content, but the format has not been made available more widely. Furthermore, there is a general lack of correlation between the various models that allows for an enhanced user experience when using the primary content. Therefore what is needed is a system and method that allows for use of meta-content models to create an interactive content model based on primary content.

### SUMMARY OF THE INVENTION

In accordance with the various aspects and embodiments of the invention, a system and a method are disclosed for creating interactive meta-content. This method allows for any type and amount of primary content (such as, but not limited to, web pages, product descriptions, articles, studies, audio, video, images, text, or any combination thereof) to be used in the creation of interactive content (such as, but not limited to, quizzes, interviews, surveys, polls, finders, matchers, sorters, assistants, help documents, wizards, concierges, conversations, artificial intelligences) about the primary content. Hence, the resulting interactive content is also meta-content.

The advantages of the invention include, without limitation, the ability to produce a piece of interactive meta-content that reduces a user's need to interact with, read, or review the primary content, which in some instances can be too much for a consumer to effectively review. For example, by taking the Stroller Quiz, the user no longer needs to interact with the Top 100 bestselling stroller product descriptions that were used as primary content, creating a significant and valuable time savings. The process also produces interactive meta-content which assists the user in their navigation of the primary content via the questions, answers, and question paths, aiding both clarity and discovery for the user, and reducing choice overwhelm and decision fatigue. Reduction of choice sets has also been shown to increase user satisfaction with their choices. In broad embodiment, the invention is a methodical way to process primary content and present useful or entertaining insights, findings, results, discoveries, and filters to the user in an interactive, matching, or personalized format.

The summary provided herein is a simplified summary of the innovation in order to provide a basic understanding of some aspects of the innovation as presented in various embodiments. The summary is not intended to identify key/critical elements of the innovation or to delineate the scope of the invention. Its sole purpose is to present some concepts of the innovation in a simplified form as a prelude to the more detailed description that follows.

### BRIEF DESCRIPTION OF THE DRAWINGS

While the specification concludes with claims defining the features of embodiments in accordance with the various aspects of the invention that are regarded as novel, it is believed that the invention will be better understood from a consideration of the following description in conjunction with the figures, in which like reference numerals/numbers are carried forward.

FIG. 1 shows a system in accordance with the aspects of the invention.

FIG. 2 shows a flowchart of steps executed by a system to perform the method of creating an interactive meta-content in accordance with the aspects of the invention.

FIGS. 3A, 3B, and 3C are flow processes for creating an online quiz based on interactive meta-content from the flow of FIG. 2 in accordance with the aspects of the invention.

FIG. 4 is an example of an aspect of the invention for selection of a dress that includes a binary question and response pair.

FIG. 5 is an example of an aspect of the invention for selection of a rug that includes a binary question and response pair.

FIG. 6 illustrates language used for building an interactive meta-content based on binary question and response pairs in accordance with the aspects of the invention.

FIG. 7 illustrates options to provide additional information to aid the user make a selection based on binary question and response pairs as well as a progress indicator and ability to share information via a link in accordance with the aspects of the invention.

### DETAILED DESCRIPTION OF THE INVENTION

Before describing in detail the embodiments that are in accordance with the various aspects of the invention, it is noted that the embodiments reside primarily in combinations of method steps and apparatus components related to facilitating access by a user to content. Accordingly, the apparatus component and method steps have bene represented where appropriate by conventional symbols in the drawings, showing only the specific details that are pertinent to understanding the embodiments of the present invention so as not to obscure the disclosure with details that will be readily apparent to those of ordinary skill in the art having the benefit of the description herein. For example, where the primary content is product descriptions for strollers for sale online, in accordance with the various aspects of the invention, the system and method provide a step-by-step process for creating the interactive meta-content of a quiz that is a Stroller Quiz.

Unless defined otherwise, all technical and scientific terms used herein have the same meaning as commonly understood by one of ordinary skill in the art to which this invention belongs. Any methods and materials similar or equivalent to those described herein can also be used in the practice of the invention. Representative illustrative methods and materials are also described.

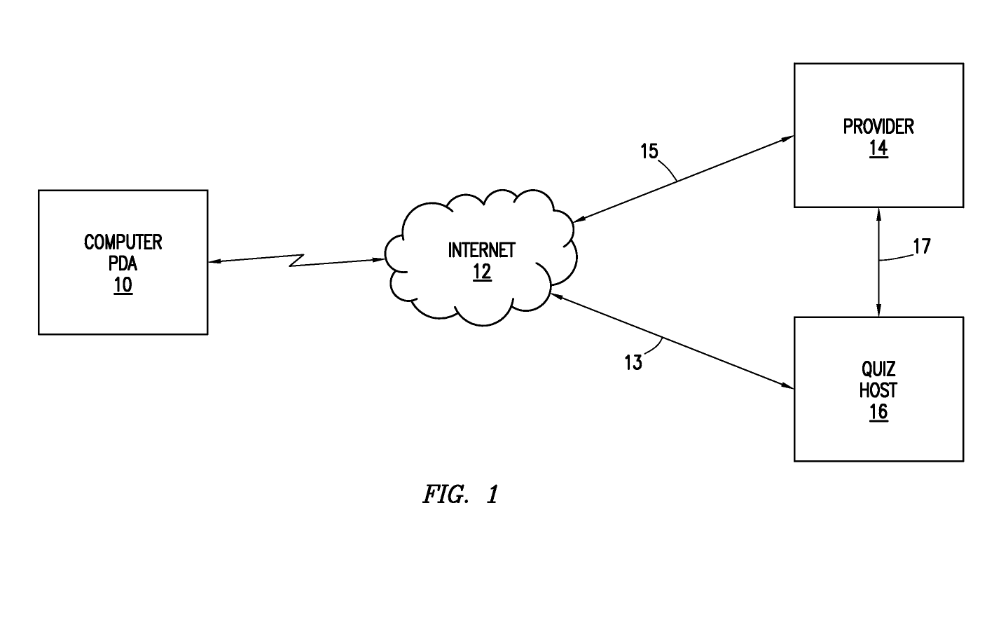

Referring now to FIG. 1, a system in accordance with the aspects of the invention. A user, through a computer or wireless communication device 10, access primary content through internet 12, which is supplemented with an interactive meta-data content. In accordance with the teachings of the invention a computer, a computing device, or a wireless communication device are articles of manufacture. An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

There are many examples of an article of manufacture that are within the scope of the aspects of the invention. For examples, an article of manufacture includes: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods. The article of manufacture (e.g., computer or wireless communication device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or microprocessor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device of a host.

Referring again to FIG. 1, in accordance with an aspect of the invention, a user accesses the primary content that is stored at a provider's server 14 through connection 15. The primary content is enhanced or supplemented with interactive meta-content in the form of a quiz, which is stored at a host server 16. The quiz is accessed by the server 14 through connection 17. In accordance with another aspect of the present invention, a user can directly access the interactive meta-content on the server 16 through connection 13. Accordingly, the server 16 accesses the primary content stored at the server 14 and presents the primary content, as supplemented and enhances by the interactive meta-content, to the user. Thus, it will be apparent to one of ordinary skill in the art that there are various approaches to accessing the primary content as supplemented by the interactive meta-content.

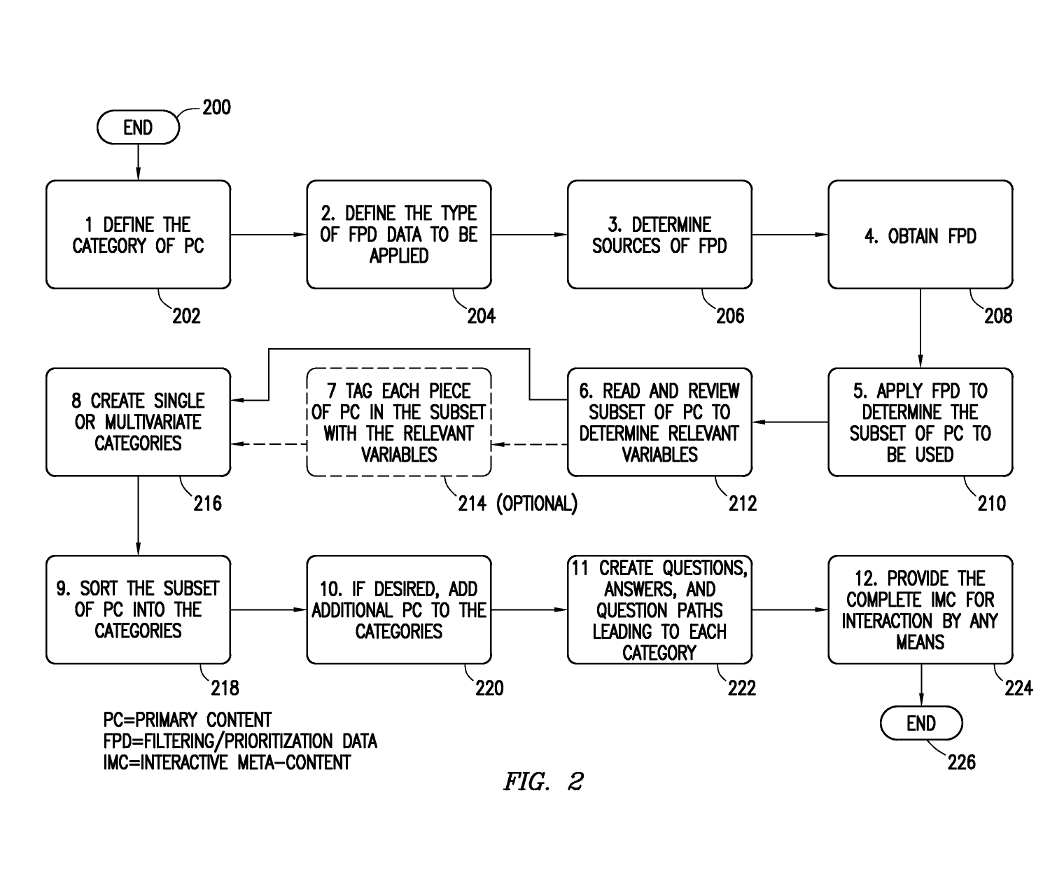

Referring now to FIG. 2, in accordance with the aspects of the invention, a process is shown for creating interactive meta-content to be associated with primary content. The process begins at 200 and helps the consumer find goods or services that fall within the consumer's specific needs and interests. In this way, a broad range of primary content is narrowed to a specific range of primary content by helping the consumer choose the correct scope. Accordingly, at step 202 a category of primary content is defined based on parameters, including but not limited to: type, topic, scope, and exclusions. The parameters merely represent an example and are not intended to limit the scope of the invention.

At step 204, the type of filtering and/or prioritization data is determined, which will be applied to the primary content. Example of such include, but are not limited to: social proof (including most shared, most followed, best sellers, most reviewed), scientific parameters, industry parameters, financial parameters, legal parameters (including non-compliant products or citation to case law if the quiz is directed at determining a legal standard or legal question), expert parameters, personal parameters, quantitative parameters, and qualitative parameters (including newest, best seller, least expensive, rating, and reviewed). At step 206, the process determines a source or sources for the filtering/prioritization data, including but not limited to: print publications, websites and online data, public information and records, and archival forms of data (e.g. microfilm and microfiche).

Once the source is identified, at step 208 the process, as implemented by the system, obtains the filtering/prioritization data, including but not limited to: Popularity data (bestselling, most viewed, most shared, most recommended, crowd-sourced, user ratings and reviews); Scientific consensus (peer-reviewed, citations, awards, test results); Industry recognitions (awards, nominations, halls of fame, “best of” lists); Financial performance (highest return on investment, volatility, book value); Legal standards (common law, case law); Expert reviews and recommendations; Personal criteria, preferences, and histories; Measurements of price, features, functionality, warranty; and Judgments of quality, beauty, value, and merit. The scope of the present invention is not limited by the examples provided.

At step 210, the process applies the filtering/prioritization data to determine the subset of primary content that shall be used to inform the interactive meta-content. For example, the process considers a narrow set of primary content to determine the most appropriate questions (and corresponding answers) for the quiz, which is then expandable to the primary content. The subset, in accordance with the various aspects of the invention, can be based on or drawn from any source. Examples of such include, but not limited to: top 20 bestsellers; all double-blind studies on hormone replacement therapy; and the American Film Institute Top 100 Horror Films. At step 212, the process includes processing of the subset of primary content to determine and select relevant variables, including but not limited to: features of the subset of primary content; characteristics; facets; specifications; capabilities; quantities; qualities; prices; and availability.

At step 214, the process tags each piece of content in the subset of primary content with the relevant variables. The process builds the tags to correspond to answers for questions in the quiz. In accordance with one aspect of the invention, the questions are selected to have exclusive or binary responses. For example, a question may be “with or without sleeves” and the response provides mutually exclusive responses. Other examples of a binary response to a question and response pair include “White or wheat?” In accordance with other aspects of the invention, the question and response pair is non-binary and includes three or more possible answers, such as “small, medium, or large?” Thus, the scope of the present invention is not limited by the binary or non-binary answers or options that included in the question and response pair. The process continues to tag the piece of primary content, such as a product or service or information, until there is at least a minimum number of pieces of primary content in each sub-category. The number in each category can range from one to three or more and the scope of the present invention is not limited thereby.

At step 216, the process creates single-variable or multivariate categories, which can be associated with one or more pieces of primary content. At step 218, the process sorts the subset of primary content into the categories. At step 220, the content categories may be further populated with additional primary content, which includes goods in accordance with one aspect of the invention. At step 222, the process creates questions, answers, and question paths leading to each category for the primary content. The questions, answers, question paths, result categories, and the primary content contained therein are included as part of an interactive meta-content. The interactive meta-content may or may not also include ancillary components such as images, question descriptions, answer descriptions, category descriptions, result descriptions, disclosures, disclaimers, clarifications, instructions, etc. The interactive meta-content may be described in a variety of ways, including but not limited to: a quiz, an interview, a survey, a wizard, a finder, a sorter, a helper, a concierge, a script, an artificial intelligence, a test, a poll, a matcher, a matchmaker, or a game. It will be apparent that any type of interactive meta-content can be created and is within, but does not limit, the scope of the present invention.

At step 224, the interactive meta-content may be provided to the consumer for interaction using any means of communication and any device or article of manufacture (such as the computer or the wireless device), including but not limited to: Verbal communication; Written communication; Telephone communication; Cellular communication; Satellite communication; Digital communication (via private network, public network, internet, or any combination thereof), and any combination of communication means.

In accordance with one aspect and embodiment of the invention, the following example is provided for a process related to the Stroller Quiz noted above. The category of primary content is product pages on Amazon.com relating to baby strollers available for immediate sale, online, in the USA, excluding double strollers and jogging strollers. The filtering/prioritization data to be used is online sales rank data. Amazon USA is selected as the source of data. Amazon USA's sales rank data is obtained via its website. Application of the data results in a subset of baby strollers, i.e. the Top 20 bestselling baby strollers on Amazon. The process reviews the primary content, i.e. product pages, including product descriptions, product images, and customer reviews to determine the relevant variables of: weight-rating (child), weight (stroller), compactness, feature-richness, and infant car seat compatibility.

Based on the relevant variables, the process creates these multivariate categories: Full featured 40-pound rated stroller; Standard 35 to 40-pound rated stroller; Ultralight 40-pound rated stroller; Infant car seat compatible stroller; Stroller frame; 50-pound rated stroller; Compact 50-pound rated stroller; Sort each of the Top 20 strollers into the correct multivariate category; Populate additional primary content into each multivariate category, so that each category contains the top 3 bestselling strollers that match the category variables.

With the categories created and populated, the process creates questions to present to the consumer, and answers options from which the consumer may choose. The process, through the question and possible responses or answers, generates question paths leading to each stroller category. For example the process can generate the following questions path associated with questions and responses: QUESTION—Do you want your stroller to be compatible with an infant car seat? RESPONSE OPTIONS—Yes or No; QUESTION—What upper weight limit would you prefer for your stroller? RESPONSE OPTIONS—40-pounds or 50-pounds (child); QUESTION—Do you prefer a lighter, more compact stroller, or a larger/sturdier stroller? Questions may have 2 or more possible responses. The interactive meta-content of “The Baby Stroller Quiz” is made available to the consumer at a web address that can be accessed by the user or consumer; for example the quiz can be made available through the internet and online at www.ABorC.com/Baby.

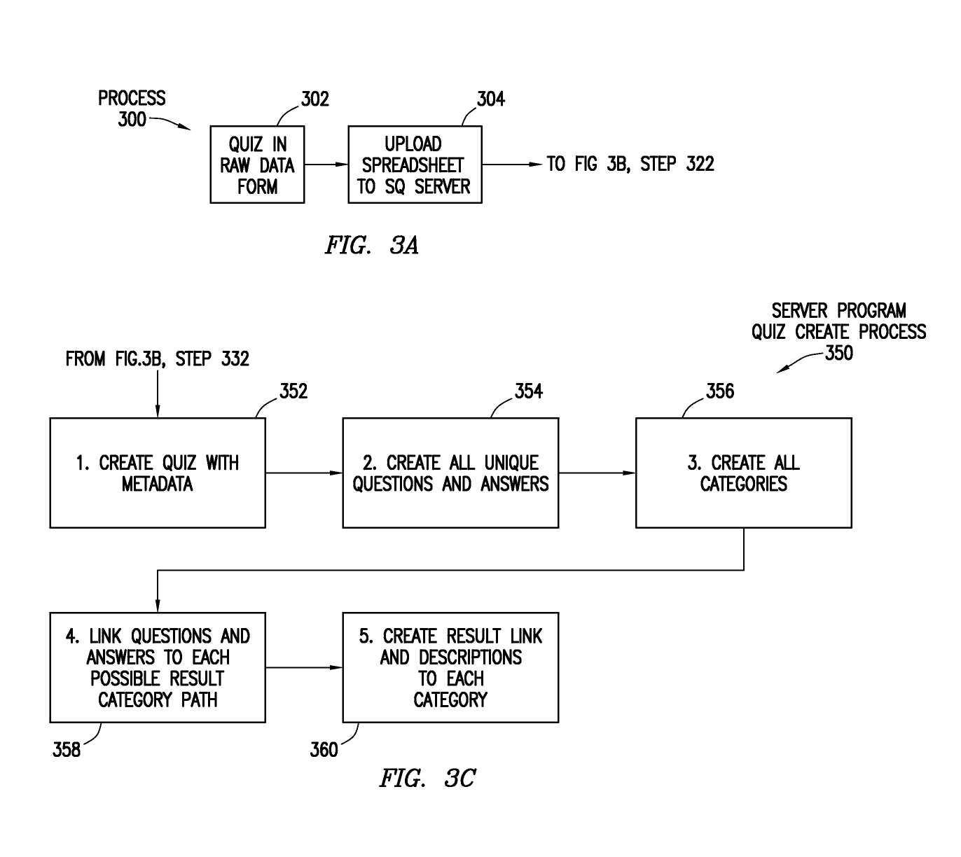

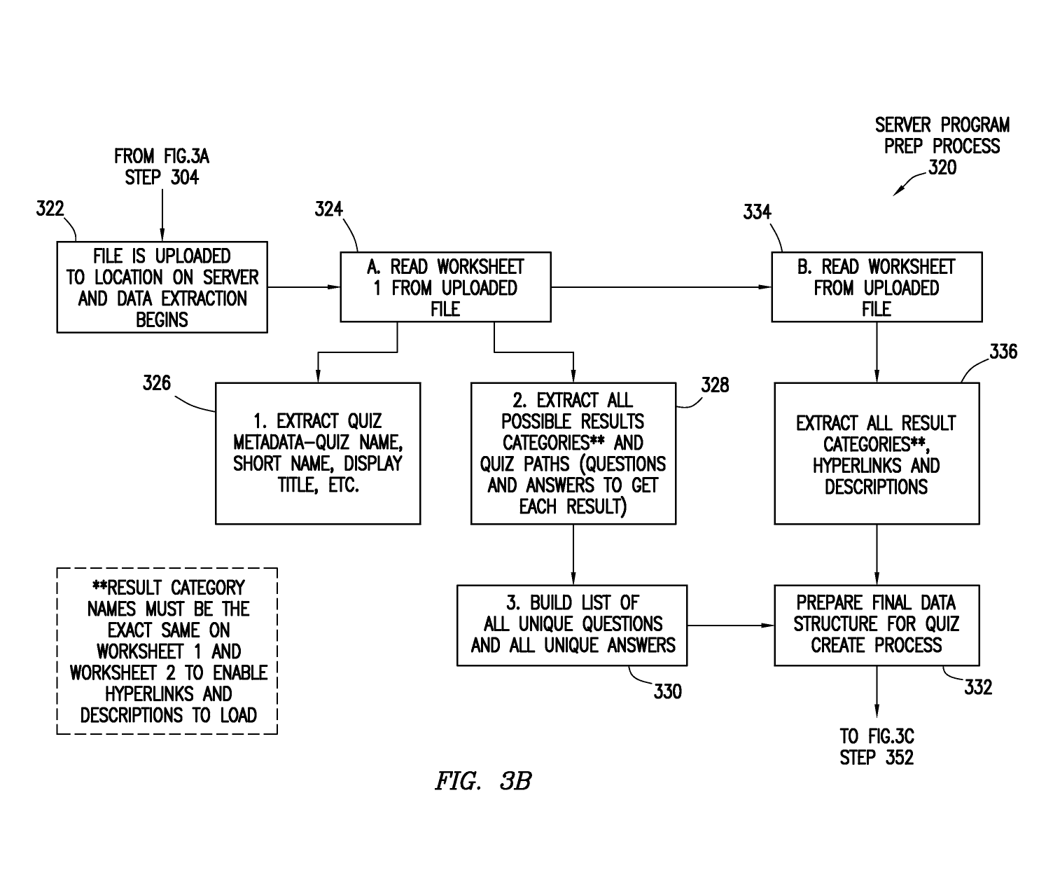

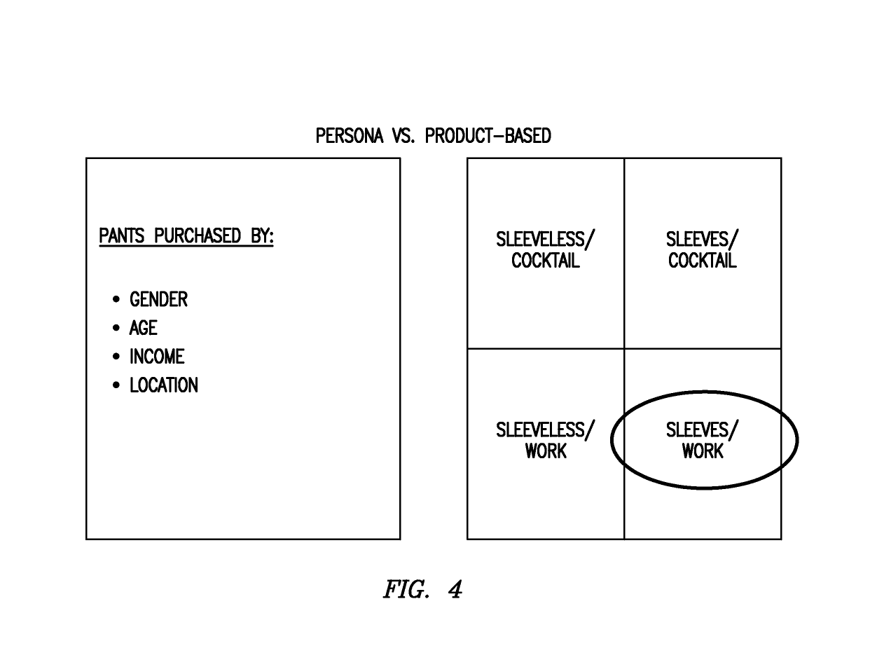

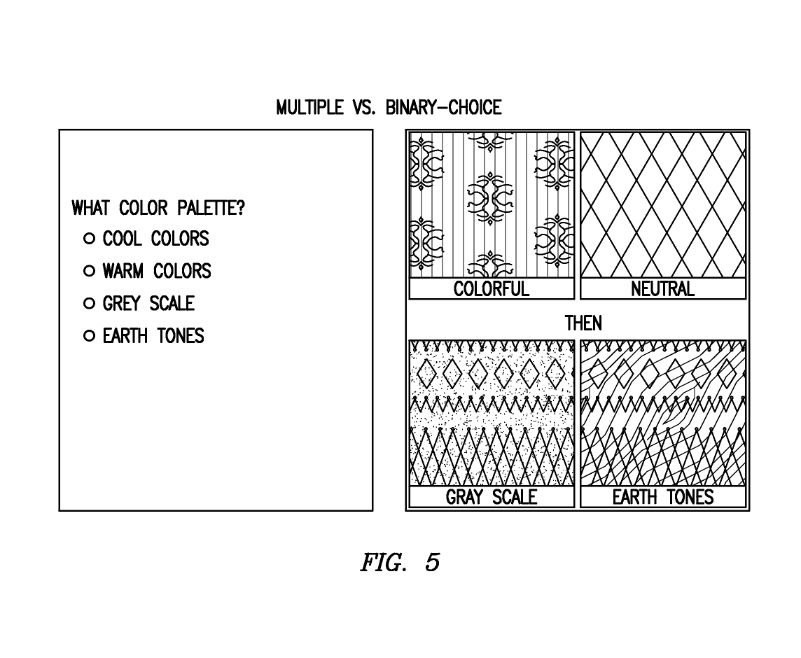

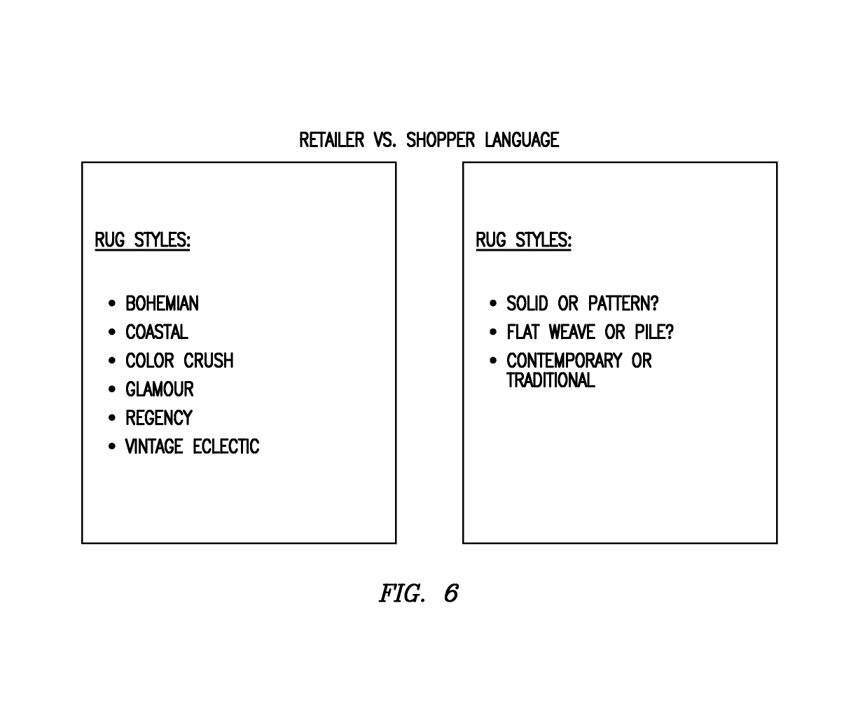

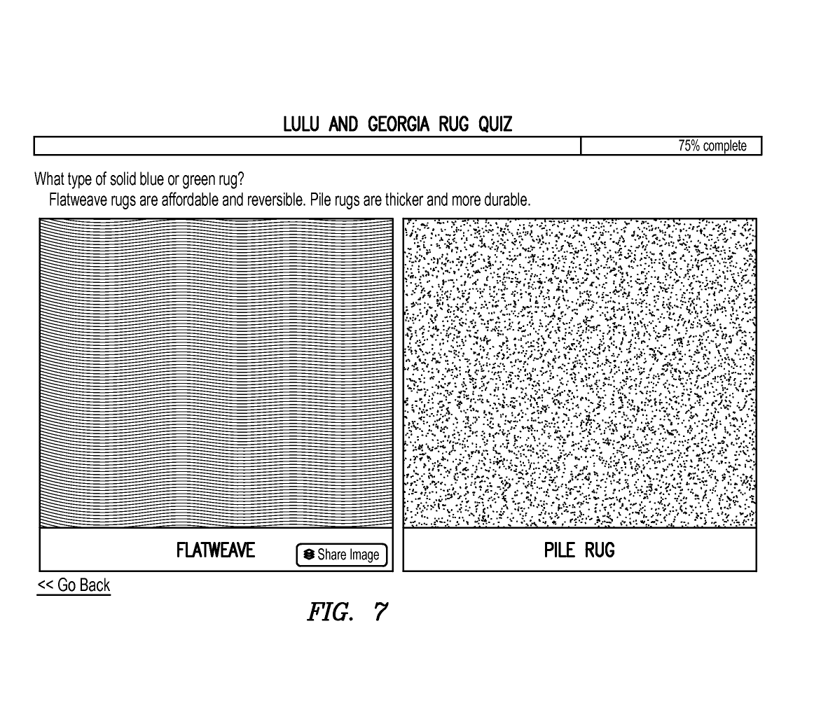

Referring now to FIG. 3, in accordance with the aspects of the invention, a process is shown for creating a quiz website, which is performed by instructions stored in non-transitory memory of the server or computer. The process for creating the interactive meta-content associated with the primary content includes three main sub-processes: at 300, loading the quiz questions and categories, as explained above, into a spreadsheet in raw data form; at 320, the server prepares the process; and at step 350, the server creates the interactive meta-content in the form of an interactive quiz that the consumer engages.

At 300, the quiz content (with raw data or information) is loaded into a spreadsheet or a file at step 302. Then at step 304, the content is loaded to the storage location, such as a Web Server. At step 322, the file containing the quiz is retrieved from the Web Server to extract the data needed to generate the final quiz. At step 324 the worksheet is read and at step 326 the metadata is extracted by the system. Also, at step 328 all possible result categories are extracted to generate the unique question and answer paths. As step 330, the unique questions and unique answers are built into the interactive quiz and at step 332 the final structure of the data for creating the quiz is prepared by the system. If there are additional worksheets, then at step 334, the second worksheet is read from the uploaded file. At step 336 the system extracts all result categories and the hyperlinks to the primary content along with any descriptions associated with the primary content.

At step 352, the system creates the quiz with the metadata. At step 354, the system creates all unique questions and answers that will be presented to the consumer as an interactive quiz. At step 356, the system creates the result categories that include one or more links to primary content. At step 358, each result category is associated with a unique pattern of questions and answers, i.e. the question and answer path. At step 360, each result category is associated with descriptions and links to the selected primary content.

In accordance with the various aspects of the invention, the system and method disclosed, as included in the process, is able to learn and predict more advantageous permutations of information presented to the user as part of the interactive meta-content. Through machine learning, the system can vary presentation of information to achieve optimal results, for example a conversation rate lift. For example, in accordance with one aspect of the invention, the system may have five question and response pairs and determine, from various users that have completed the interactive meta-content, a combination of question and response pairs selected from the five possible question and response pairs, that produces the best results. Other examples of variations that the system can implement, based on machine learning techniques, include variations of question wording, response wording (for example synonyms or between singular and plural forms), changes in the photos presented, changes in the visual presentation (colors, fonts, shapes, etc.), changes in the order that the questions are presented, and variations in the presentation of the information associated with the primary content (for example, with or without prices, number of photos, etc.), and variation in which pieces of primary content presented. As will be apparent to one skilled in the art, the scope of the present invention is not limited thereby.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

As will be apparent to those of skill in the art upon reading this disclosure, each of the aspects described and illustrated herein has discrete components and features which may be readily separated from or combined with the features and aspects to form embodiments, without departing from the scope or spirit of the invention. Any recited method can be carried out in the order of events recited or in any other order which is logically possible.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention, therefore, is not intended to be limited to the various aspects discussed and described herein. Rather, the scope and spirit of invention is embodied by the appended claims.

What is claimed is:

1. A non-transitory computer-readable storage medium carrying one or more sequences of one or more instructions, which when executed by one or more processors, cause an apparatus to generate an interactive meta-content by performing at least the following steps:
identify at least one category associated with a set of primary content, wherein the category includes at least one piece selected from the set of primary content;
determine a filtering process, wherein the filtering process is based on data associated with the set of primary content;
generate, using the filtering process, at least one subset of the set of primary content;
determine a plurality of sub-categories within the at least one subset;
populate at least one sub-category of the plurality of sub-categories with the at least one piece;
generate question and response pairs to produce a plurality of paths, wherein each path leads to one sub-category of the plurality of sub-categories; and
generate an interactive quiz based on the question and response pairs to produce the interactive meta-content for accessing the set of primary content.

2. The non-transitory computer-readable storage medium of claim 1, wherein at least one question and response pair is a binary question and response pair.

3. The non-transitory computer-readable storage medium of claim 1, wherein at least one question and response pair is a non-binary question and response pair.

4. The non-transitory computer-readable storage medium of claim 1, wherein at least one sub-category of the plurality of sub-categories is empty.

5. A system for generating an interactive meta-content that allows a user to access a set of primary content, the system comprising:
a device that allows a user to access the interactive meta-content;
a server including memory and at least one processor, the server including information about the set of primary content; and
an apparatus including at least one processor and memory for storing a sequence of instructions, such that when the instructions are executed by the processor, the apparatus is caused to present the interactive meta-content to the device and upon the user completing a quiz, the apparatus presents the users with at least one sub-category.

6. The system of claim 5, wherein the at least one sub-category is empty. The system of claim 5, wherein the at least one sub-category includes at least one piece of the set of primary content.

8. The system of claim 5, wherein the quiz includes at least one binary question and response pair.

9. The system of claim 5, wherein the quiz includes at least one non-binary question and response pair.

10. An apparatus comprising:
at least one processor; and
memory including computer program code for one or more programs, the memory and the computer program code configured to, with the at least one processor, cause the apparatus to at least perform the following:
identify a plurality of unique sub-categories;
populate each of the unique sub-categories with, at least one of, a piece of primary content and a null result message;
identify at least one question and response pair to associate with each of the unique sub-categories; and
generate an interactive meta-content based on the unique sub-categories and the associated question and response pairs.

11. The apparatus of claim 10, wherein the at least one question and response pair is a binary question and response pair.

12. The apparatus of claim 10, wherein the at least one question and response pair is a non-binary question and response pair.
